(19) United States
(12) Patent Application Publication
(10) Pub. No.: US 2006/0244863 A1
(43) Pub. Date: Nov. 2, 2006

(54) On-screen assisted on-screen display menuing systems for displays

(76) Inventors: John Baikie, Laguna Beach, CA (US); Timothy Almedia, Corona, CA (US)

Correspondence Address: GATEWAY, INC.;ATTN: Patent Attorney, 610 GATEWAY DRIVE, MAIL DROP Y-04, N. SIOUX CITY, SD, 57049, US

(21) Appl. No.: 11/412,007

(22) Filed: Apr. 26, 2006

Related U.S. Application Data
(60) Provisional application No. 60/675,293, filed on Apr. 27, 2005.

(51) Int. Cl. H04N 5/50

(52) U.S. Cl. 348/569

(57) ABSTRACT

A system for facilitating adjustment of a display characteristic of a display. The system may comprise a display including a cabinet having an opening with a perimeter, a screen mounted on the cabinet and positioned adjacent to the opening of the cabinet to permit viewing of the screen through the opening, and a control element for controlling an aspect of a display characteristic of the screen, with the control element being positioned on the cabinet. The display may include display control circuitry for controlling display characteristics of the screen and being operatively connected to the control element such that actuation of the control element influences one of the display characteristics. The display control circuitry is configured to display indicia on the screen associated with the control element, with the indicia being positioned on the screen in a location than creates a spatial association between the indicia and the control element.

### BACKGROUND OF THE INVENTION

1. Field of the Invention

The present invention relates to onscreen displays and more particularly pertains to a new on-screen display menuing system for providing on screen assistance to the user of the display in operating and navigating the on screen display menus.

2. Description of the Prior Art

On-screen display (OSD) menus have been implemented on displays for information handling systems to show the current settings of various display characteristics of the display, and to assist the user in changing or adjusting those display characteristic settings. The settings of the display characteristics are typically adjusted by actuating various buttons, dials, knobs, and the like located on the cabinet of the display. Initiating the display of an OSD menu is typically triggered by the user by, for example, pushing one of the buttons on the display cabinet that activates circuitry in the display that generates the OSD menu on the screen of the display. The OSD menus list a portion of the display characteristics that are available for adjustment, and the user navigates through these display characteristics to select one display characteristic and display the current setting of the characteristic (such as a value between 1 and 10).

Typically, only a portion of the adjustable display characteristics can be displayed on the screen at one time, and so the user must scroll through the listing of display characteristics to find the desired characteristic to be adjusted. The scrolling is usually effected by pressing one of the buttons on the cabinet to move in one direction through the list and another button to move the other direction through the list. Once the desired display characteristic is located on the listing, the user must then switch to pressing another set of buttons on the cabinet to increase or decrease the value or level of the setting of that display characteristic.

To reduce the number of buttons on the cabinet of the display, typically one button will perform two or more functions, and the surface of the button, or the surface of the cabinet adjacent to the button, will bear two or more (short) labels or symbols intended to give the user some idea of what the button is intended to control. Because these labels or symbols are typically fairly cryptic, the screen of the display may also display some short description of the function of the buttons next to a representation of the label or symbol on the corresponding button. But since these descriptions are spatially disassociated from the buttons, the user must match the labels or symbols on the screen with the same on the buttons. Further, in some displays, the labels or symbols are typically impressions or indentations in the surface of the material of the cabinet, which makes the labels or symbols difficult to see and read. One alternative to the group of dual function buttons that has been implemented is a rotatable disc on the cabinet of the display that causes movement of a highlight bar or pointer along the listing of display characteristics on the screen, but this control is fairly limited in what it can do (i.e., rotation in two directions and pushing), and its use is not familiar or intuitive to many users.

As a result of these factors, OSD menus have been extremely difficult for users to operate and navigate. Typically, when OSD menus are activated, the user does not easily know or recognize which button to press to advance along the listing of display characteristics, select one of the display characteristics to modify the setting of the characteristic, and cause the modification of the setting value of the desired display characteristic. Not only does the user often find this process confusing and exasperating, this confusion can result in technical support calls to the customer or technical support center for the manufacturer of the display or the seller of the display, which increases the costs for these entities.

It is therefore believed that there exists a need for a simplified on-screen menu system that provides a more intuitive indication to the user of the manner of adjusting the settings of the various display characteristics.

### SUMMARY OF THE INVENTION

The present invention provides a new system that provides on screen assistance to the user of the display in operating and navigating the on screen display menus by providing spatial association between the command and the control element for changing the setting for that function.

In one aspect of the invention, a system for facilitating adjustment of a display characteristic of a display is provided, and comprises a display that includes a cabinet having an opening with a perimeter, a screen mounted on the cabinet and positioned adjacent to the opening of the cabinet to permit viewing of the screen through the opening, and at least one manually-actuatable control element for controlling an aspect of a display characteristic of the screen, with the at least one control element being positioned on the cabinet. The display includes display control circuitry for controlling display characteristics of the screen, with the display control circuitry being operatively connected to the at least one control element such that actuation of the at least one control element influences one of the display characteristics. The display control circuitry is configured to display indicia on the screen associated with the at least one control element, the indicia being positioned on the screen in a location than creates a spatial association between the indicia and the at least one control element.

The foregoing is a general outline of some of the more significant aspects of the invention, and the detailed description of this application that follows discloses additional features of the invention which form the subject matter of the claims appended hereto.

One significant aspect of the present invention is that the user is provided a visual and spatial association between the command for changing a display characteristic and the control element that needs to be actuated to change the setting for the display element.

Further advantages of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated preferred embodiments of the invention.

### BRIEF DESCRIPTION OF THE DRAWINGS

The invention will be better understood and objects of the invention will become apparent when consideration is given to the following detailed description thereof. Such description makes reference to the annexed drawings wherein:

FIG. 1 is a schematic front view of a display employing the new on-screen assisted on-screen display menuing system of the present invention, showing a main menu screen.

FIG. 2 is a schematic front view of a display showing a sub menu screen of the present invention.

FIG. 3 is a schematic front view of a display showing a variation of a sub menu screen of the present invention.

FIG. 4 is a schematic front view of a display showing another variation of a sub menu screen of the present invention.

FIG. 5 is a schematic front view of a display showing yet another variation of a submenu of the present invention.

FIG. 6 is a schematic block diagram of a display capable of implementing the present invention.

FIG. 7 is a schematic perspective view of a broken away portion of a display monitor showing one optional variation of the present invention in which the buttons are located on a side of the screen panel

### DESCRIPTION OF PREFERRED EMBODIMENTS

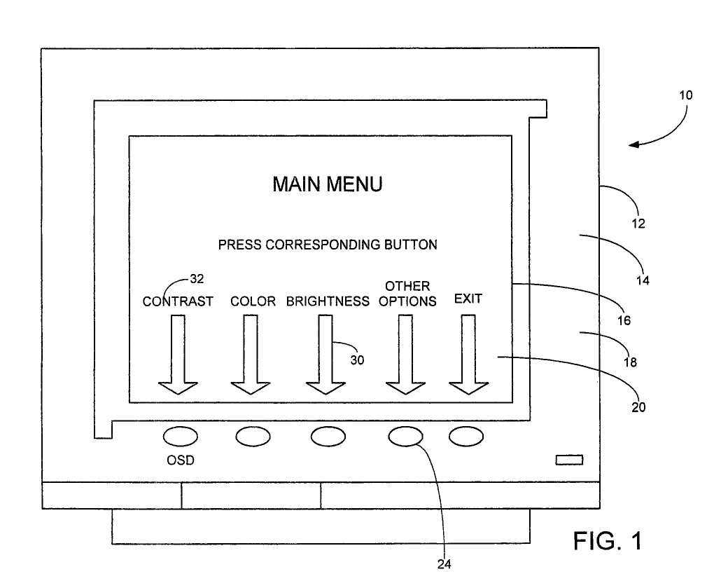

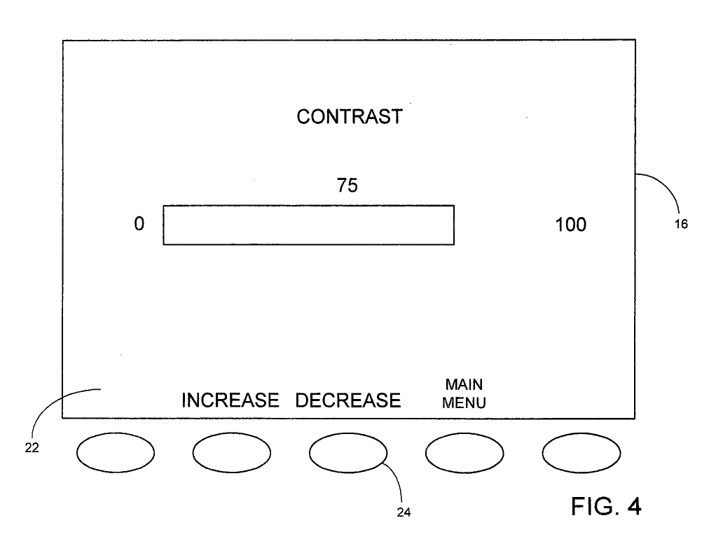

With reference now to the drawings, and in particular to FIGS. 1 through 7 thereof, a new on-screen assisted on-screen display menuing system embodying the principles and concepts of the present invention and generally designated by the reference numeral 10 will be described.

In a general sense, the invention comprises a system for providing additional on-screen assistance for a user of a display 12 in adjusting the characteristics of the display, including the aspects that affect the appearance of the images that are displayed or shown on the display, and may include the aspects that affect the operation of the display, such as, for example, the operation of an on screen display (OSD) menu and the ability of the user to navigate through the OSD menu. Typically, an OSD menu includes a main or primary menu of with a listing of a number of display characteristics, and a plurality of submenus that are directed to one or more of the individual display characteristics and that facilitate the adjustment of one or more of the individual characteristics. The user initiates the OSD menu system, and then navigates through the menu system, by actuating one or more control elements located on the display. The present invention significantly enhances the usability of the OSD menus by creating a stronger and clearer visual association between the control elements and the functions they are intended to adjust.

In greater detail, and as generally shown in FIG. 1 of the drawings, the invention is most suitably implemented on a display 12. When used in conjunction with an information handling system such as, for example, a personal computer, the display is often referred to as a monitor, because it has a limited ability to generate images or characters to be displayed, and instead relies upon the components of the information handling system, such as the central processing unit (CPU) and any dedicated video processors to generate the images and characters displayed. One significant exception is the circuitry and software applications for generating the OSD menus, which is typically integrated into the monitor, although it could be implemented on the information handling system. As the control elements for the OSD menus are typically integrated into the display, it is preferable to have the OSD circuitry and software also integrated into the monitor. However, the invention is not limited to those displays that have the OSD-implementing circuitry or software resident in the display itself, and such circuitry or software could be located elsewhere, such as, for example, in the information handling system. It should be recognized that the invention may be utilized on other types of displays, including those that include greater image generating capabilities, such as televisions and convergence devices that include television and information handling systems in the same unit.

The display 12 may comprise a housing or cabinet 14 that encloses most of the components of the display. Typically, the cabinet 14 is separate from the other components of the information handling system, but the cabinet may also form a portion of a larger device, such as in the application of a laptop or portable computer where the display 12 is typically connected in some manner to other housings. The cabinet 14 has an opening 16 that extends through a wall of the cabinet, and an exterior surface 18 of the wall of the cabinet surrounds the opening.

The display 12 also includes a screen 20 that generates the visually perceptible images for viewing by the user. The screen 20 is mounted on or in the cabinet 14, and is typically positioned adjacent to the opening 16 of the cabinet 14 so that the image-generating circuitry is enclosed in the cabinet while the display surface 22 of the screen is viewable from the exterior through the opening. It will be recognized that the invention may be implemented on virtually any type of screen technology, including, for example, cathode ray tube (CRT) screens, liquid crystal diode (LCD) screen, plasma screens, or other display screen technologies now known or developed in the future.

The display 12 includes at least one manually-actuatable element 24 for controlling an aspect of the display or operation of the display. Typically, but not necessarily, the display will include two or more of the manually actuatable elements 24. In the illustrative embodiment shown in the drawings, five of the elements 24 are included on the display, although it should be understood that the implementation of the invention on a display may permit the use of fewer elements 24 than is typically used, and the number of elements 24 could be significantly less than five. Each of the manually-actuatable elements 24 may be mounted on the cabinet 14, and is generally positioned on the cabinet proximate to the opening 16 in which the screen 20 resides. It will be recognized that the elements 24 may be visible to the user on the cabinet 14 when the user is viewing the screen 20, so that the user is able to make a visual association between the element 24 and images being displayed on the display surface 22 of the screen. In some embodiments, the manually-actuatable element 24 may be located adjacent to the screen, and in some cases may be positioned closely adjacent to the opening 16 in the cabinet 14. The character of the screen technology may dictate the proximately possible between the elements 24 and the screen 20, although it is emphasized that the elements 24 merely need to be visible to the user as the user is able to see the display surface 22 of the screen. However, it should be understood that the elements 24 need not be visible to the user at all viewing positions of the display surface 22, and the elements 24 do not necessarily need to be visible to the user when the user is operating the elements 24, but it can be very helpful to the user to be able to view both the display surface 22 and the elements 24 simultaneously.

The manually-actuatable elements 24 typically comprise a switch, such as a momentary switch that is electrically connected to circuitry of the display 12 that control the operation of the display. The switches of the elements 24 are typically embodied as buttons on the cabinet 14 that are actuated by manually pressing on the button. It should be recognized that other switch technology may be used, such as dials, thumbwheels, rockers, and the like, and the effectiveness of the invention is not limited to any one type of switch. The actuatable elements 24 may be located beneath or below the opening 16 of the cabinet 14, but may be located to one of the vertical sides of the screen.

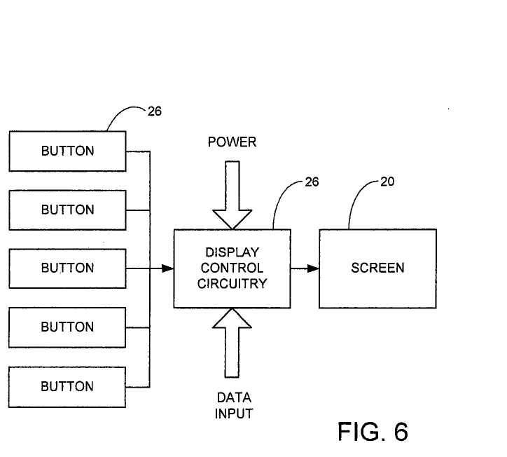

As shown in FIG. 6, the display 12 may also include display control circuitry 26 for controlling display characteristics of the screen, and typically will also include the software programming for implementing the OSD menu and the features of the present invention. The display control circuitry 26 is operatively connected to the manually-actuatable elements 24 such that actuation of the elements 24 influences or controls one of the characteristics of the display. For example, actuation of one of the manually-actuatable elements 24 may change a setting level of one of the display characteristics.

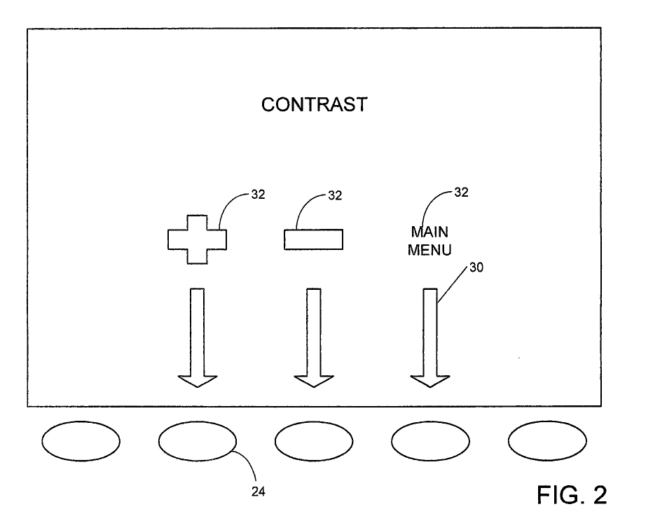

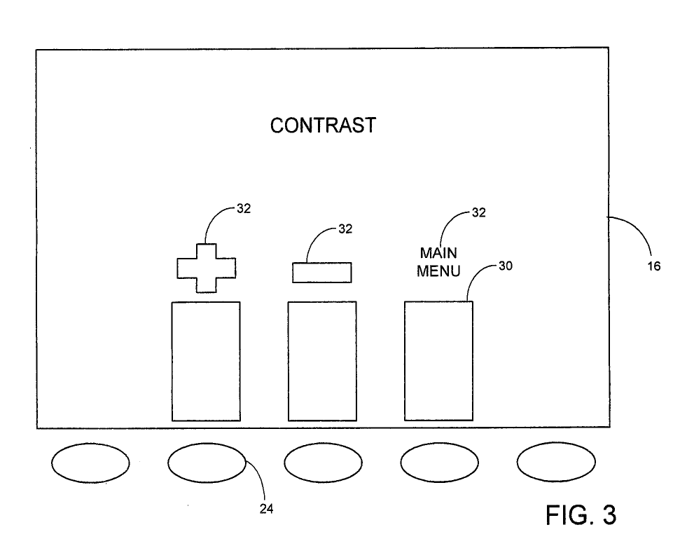

A significant feature of the invention is the indicia 30 displayed on the screen 20, and more particularly the display surface 22 of the screen, when the OSD menu is being displayed on the screen. The indicia 30 is preferably an integral part of the OSD menu application, but may be implemented separately as an overlay. In the most general sense, the indicia 30 creates an association or mental connection between an action or command 32 of the OSD menu and the manually-actuatable element 24 that must be actuated to invoke the portion of the OSD menu that is associated with the command 32. This association may be created by an indicium that points from the command 32 on the OSD menu to the actuatable element 24 that produces or causes or affects the object of the command 32 of the OSD menu. For example, the indicium 30 may be an arrow that points to the appropriate element 24 (see FIGS. 1 and 2). Another example of an indicium 30 is a bar or stripe that extends from the command toward the appropriate element 24 (see FIG. 3). Yet another example of an indicium 30 is a broken line comprised of spaced line segments extending from the command 32 toward the appropriate element 24.

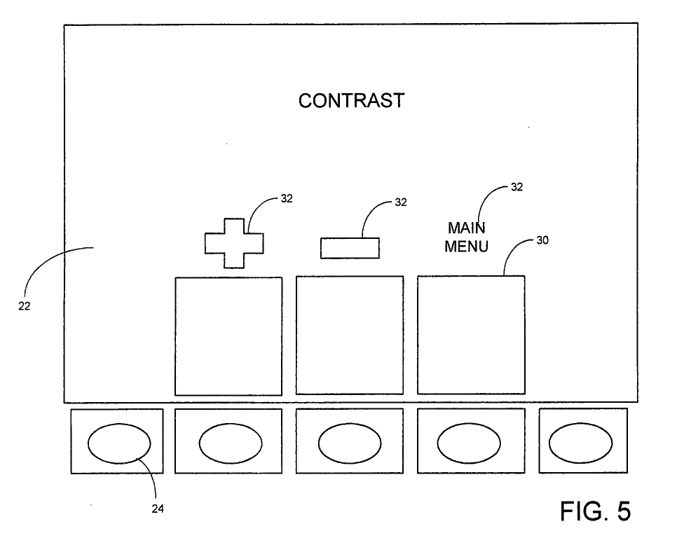

In a variation shown in FIG. 5, the area of the exterior surface 18 of the cabinet 14 may be marked in a way that is similar to the indicium 30 shown on the display surface 22 of the screen 20, such as by a bar or stripe that aligns with the bar or stripe on the screen and appears to be a continuation of the bar. A variation in color between the bars may enhance the association between the indicium and the marking, and further differentiate between other bars and markings. Optionally, the button of the element 24 may be colored to match the indicium 30.

Other possibilities will be evident to those skilled in the art, including movement of the indicium 30 toward the appropriate button 24, such as an arrow that moves from the command 32 toward the button 24, or a series of bars that are highlighted in a wave-like fashion that moves toward the button 24.

The command 32 may be represented by an icon, text, or a symbol. For example, the command 32 may be an icon such as a sun, a screen symbol in which the image is shown misaligned with the display, a partially shaded circle, and the like. Similarly, for example, the command 32 may be a word or abbreviation of a word or acronym, such as “CONTRAST”, “INCREASE”, “DECREASE”, “UP”, “DOWN” “PREVIOUS”, “NEXT”, “BACK”, “EXIT” “OSD,OFF”, “BRIGHTER”, “DARKER”, “HIGHER”, “LOWER” and the like. The command may also be a symbol, such as, for example, a “+” (plus) sign, a “−” (minus) sign, an upwardly pointing arrow, a downwardly pointing arrow, and the like. Optionally, the command 32 may be positioned in a manner such that it is closely adjacent to the actuatable element 24, to create an association by proximity between the command and the element 24.

The system 10 of the invention thus presents OSD menu options on the screen 20 of the display, along with indicium 30 that visually associates choices or options on the OSD menu with the buttons 24 on the display that invoke each of those options. Significantly, the user is adjusting various display or operational characteristics of the display 12 while the user is viewing the screen 20 of the display, and can observe the effects of the changes in the display characteristics (usually in real time), or can navigate through the OSD menus. Thus, while the indicium 30 may assist in the navigation through the OSD menu, the indicium may also create the desired association while the user is viewing the same menu and simply adjusting the setting of one of the display characteristics. The functions or options associated with each of the actuatable buttons 24 may thus be changed by changing the command 32 and indicium 30 associated with that command. The system of the invention has the capability of reducing the number of buttons necessary on the cabinet, as well as reducing or eliminating the need to label, either with markings or molded impressions, each of the buttons with the corresponding functions or characteristics.

The display characteristics that may be controlled by an OSD menu include brightness, contrast, tint, gamma, horizontal position, horizontal size, vertical position, vertical size, pincushion, trapezoid, horizontal moire, vertical moiré, color temperature, rotation, OSD text language, color, red, green, blue, temperature, tracking, clock, phase, resolution, refresh rate, input type, and the like. Further, operation characteristics of the display, or the OSD menu itself, may also be controlled, including invoking a menu, exiting the menu, storing the settings of the display characteristics, and selecting stored or factory presets.

Optionally, while the user will typically initiate or trigger the OSD menu on the display, in some embodiments of the invention the OSD menu may be triggered in other ways, such as, for example, by the powering up of the display for the first time after leaving the production or testing facility, or by the information handling system or other outside entity providing signals to the display.

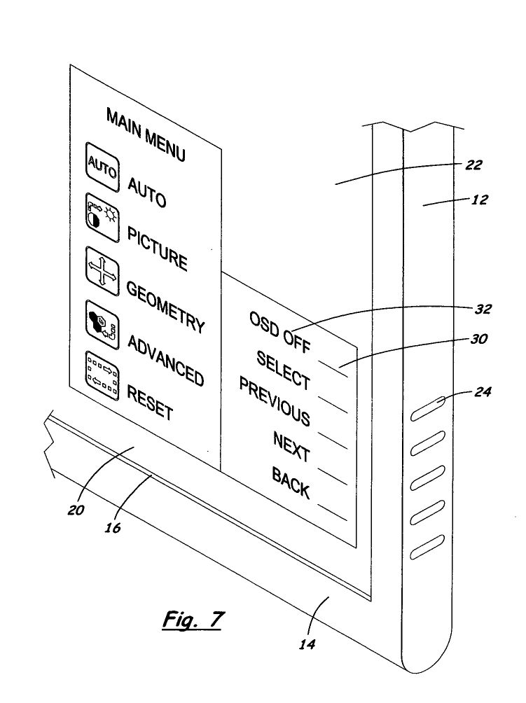

As noted above, the position of the manually-actuatable elements 24 on the cabinet 14 may be varied while still providing the advantages of the invention. More specifically, as illustrated in FIG. 7, the manually-actuatable elements 24 may be located on a side panel 40 of the cabinet 14 which permits the elements 24 to move from the front of the bezel and permits a relatively narrower bezel to be employed. In the illustrated variation, the surface 42 of the side panel 40 lies in a plane that is oriented substantially perpendicular to a plane in which the front plane of the bezel of the cabinet 14 lies, although the plane of the side panel surface 42 may be positioned at different orientations with respect to the plane of the bezel. It is conceivable that the manually-actuatable elements 24 may be located on a backside of the cabinet 14, especially if the width of the side panel is relatively thin so that the elements 24 are located relatively close to the indicia 30 displayed on the screen 20 and the spatial association therebetween is not lost. As shown in FIG. 7, in the various menus, the individual indicia 30 are displayed on the display surface 22 at a vertical level that substantially corresponds to the vertical level of the corresponding element 24 that is employed to adjust the setting of the display characteristic associated with the individual indicia 30. As noted above, various devices such as bars, lines, arrows, and the like may be displayed to indicate the vertical level at which the appropriate element 24 is located on the side panel 42, so that it the user is able to locate the element 24 in a tactile manner without having to actually view the side panel of the cabinet 14 to visually locate the element 24.

With respect to the above description then, it is to be realized that the optimum dimensional relationships for the parts of the invention, to include variations in size, materials, shape, form, function and manner of operation, assembly and use, are deemed readily apparent and obvious to one skilled in the art in light of the foregoing disclosure, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

We claim:

1. A system for facilitating adjustment of a display characteristic of a display, comprising:
a display comprising:
a cabinet having an opening with a perimeter;
a screen mounted on the cabinet and positioned adjacent to the opening of the cabinet to permit viewing of the screen through the opening;
at least one manually-actuatable control element for controlling an aspect of a display characteristic of the screen, the at least one control element being positioned on the cabinet; and
display control circuitry for controlling display characteristics of the screen, the display control circuitry being operatively connected to the at least one control element such that actuation of the at least one control element influences one of the display characteristics;
wherein the display control circuitry is configured to display indicia on the screen associated with the at least one control element, the indicia being positioned on the screen in a location than creates a spatial association between the indicia and the at least one control element.

2. The system of claim 1 wherein the indicia on the screen is displayed adjacent to a position of the at least one control element on the cabinet.

3. The system of claim 1 wherein the indicia on the screen is visually aligned with the position of the at least one control element

4. The system of claim 1 wherein the indicia on the screen extends in a direction toward the position of the at least one control element.

5. The system of claim 1 wherein the indicia is elongated along an axis that intersects with the position of the at least one control element.

6. The system of claim 1 wherein the indicia incorporates movement, and wherein the movement moves toward the position of the at least one control element.

7. The system of claim 1 wherein the indicia includes a color, and wherein the at least one control element includes the same color as the color of the indicia.

8. The system of claim 1 wherein the indicia includes a command legend displayed on the screen, and the command legend describes the display characteristic controlled by the at least one control element.

9. The system of claim 1 wherein the cabinet has a front surface in which the opening is located, the at least one control element being located on the front surface of the cabinet.

10. The system of claim 1 wherein the cabinet has a front surface in which the opening is located, and a side surface extending substantially perpendicular to the front surface, the at least one control element being located on the side surface of the cabinet.

11. The system of claim 1 wherein the at least one control element comprises a button.

12. The system of claim 1 wherein actuation of the at least one control element changes a setting level of one of the display characteristics.
